(19) United States
(12) Patent Application Publication
(10) Pub. No.: US 2025/0166870 A1
(43) Pub. Date: May 22, 2025

(54) DIRECT-CURRENT SUPERCONDUCTING LIQUID HYDROGEN ENERGY PIPELINE SYSTEM WITH LIQUID NITROGEN COLD SHIELDS

(71) Applicant: CHENGDU JINGZHIYI TECHNOLOGY CO., LTD., CHENGDU (CN)

(72) Inventors: YONG LIAO, CHENGDU (CN); SHIYI CHEN, CHENGDU (CN); FAN LI, CHENGDU (CN); BOYU QIN, CHENGDU (CN); HONGZHEN WANG, CHENGDU (CN); QIANJUN ZHANG, CHENGDU (CN); YAN WANG, CHENGDU (CN); YIFAN HU, CHENGDU (CN); FANGZHENG PENG, CHENGDU (CN); LINDONG ZHANG, CHENGDU (CN); GUORONG WANG, CHENGDU (CN)

(73) Assignee: CHENGDU JINGZHIYI TECHNOLOGY CO., LTD., CHENGDU (CN)

(21) Appl. No.: 18/835,710

(22) PCT Filed: Jul. 5, 2023
(86) PCT No.: PCT/CN2023/105912

§ 371 Date: Aug. 2, 2024

(30) Foreign Application Priority Data
Aug. 8, 2022 (CN) 202210944639.X

(51) Int. Cl. H01B 12/16; C25B 15/08; F17C 7/04

(52) U.S. Cl. CPC H01B 12/16; C25B 15/08; F17C 7/04; F17C 2205/0355; F17C 2221/012; F17C 2227/0135; F17C 2227/0302; F17C 2265/068; F17C 2270/0527

(57) ABSTRACT

Present disclosure relates to a DC superconducting liquid hydrogen energy pipeline system with liquid nitrogen cold shields, including a starting station, one or more intermediate stations, and a terminal station connected sequentially through a liquid hydrogen superconducting pipeline with liquid nitrogen cold shields. Liquid hydrogen superconducting energy pipeline with liquid nitrogen cold shields includes liquid hydrogen transmission pipeline, a liquid nitrogen cold shield layer, the external cold insulation layer and the superconducting cable group arranged inside liquid hydrogen transmission pipeline having a liquid nitrogen cold shield in an outer section of the liquid hydrogen transmission pipeline. Present invention can be applied to a large new energy base for DC superconducting transmission of electricity, and excess power can generate hydrogen, and hydrogen generated provides a low-temperature environment for realizing superconductivity after liquefaction. DC superconducting liquid hydrogen energy pipeline system efficiently transmits electricity in large capacity and low loss.

### CROSS-REFERENCE TO RELATED APPLICATION

This application is a continuation of international PCT application serial no. PCT/CN2023/105912, filed on Jul. 5, 2023, which claims the priority to Chinese patent application No. 202210944639.X, entitled “Direct-current Superconducting Liquid Hydrogen Energy Pipeline System with Liquid Nitrogen Cold Shields”, filed to China National Intellectual Property Administration on Aug. 8, 2022. The entireties of the above-mentioned patent applications are hereby incorporated by reference herein and made a part of this specification.

### FIELD

The present disclosure generally relates to electrical power transmission, and more particularly to a superconducting cable pipeline, a direct-current superconducting liquid hydrogen energy pipeline system with liquid nitrogen cold shields, and methods of using the direct-current superconducting liquid hydrogen energy pipeline system with liquid nitrogen cold shields.

### BACKGROUND

With the rapid growth of global energy consumption, the depletion of fossil energy and global climate change have brought great challenges to the sustainable development of human society. In order to curb this trend, the construction of a new power system with new energy will become a mainstream trend. The large-scale development and utilization of new energy represented by wind power and photovoltaic power has alleviated energy scarcity and environmental problems to a certain extent.

However, with the large-scale development of new energy, the uneven distribution of energy resources and load resources leads to new challenges in energy production and transmission: (1) a challenge of new energy consumption. The uncoordinated development of grid sources in certain countries seriously restricts the consumption of new energy, and the new energy enrichment base has problems such as the relatively lagging planning and approval of power grid transmission projects supporting the development and the insufficient capacity of inter-provincial and cross-regional channels, which has become a rigid constraint restricting the consumption of new energy. (2) The challenge of large-scale long-distance power transmission.

In most countries, energy production and consumption centers are not distributed evenly, with load consumption centers mainly in one part of the country and energy production centers concentrated in another part of the country. In order to solve the problem of uneven distribution of energy resources, various governments have deployed some long-distance power transmission projects. However, these projects require huge land space to build such energy channels. Therefore, compared with the traditional transmission system, the superconducting transmission system is considered to be a disruptive technology in the field of future energy transmission due to its advantages of large transmission capacity, low line loss, high transmission efficiency and compact structure. It is desirable to have superconducting energy pipeline system combined with the co-transmission of liquid hydrogen prepared from renewable energy to solve the two major problems of energy storage and transmission at the same time.

Therefore, heretofore unaddressed needs still exist in the art to address the aforementioned deficiencies and inadequacies.

### SUMMARY

In one aspect, the present disclosure relates to a superconducting cable pipeline. In certain embodiments, the superconducting cable pipeline is formed by connecting a group of superconducting cable pipes in sequence. Each of the group of superconducting cable pipes includes: a superconducting cable group, a liquid hydrogen pipeline, a group of cable supporting members, an internal insulation layer, a liquid nitrogen cold shield, and an external cold insulation layer. The superconducting cable group is used to transmit a DC power to a remote destination. The superconducting cable group is positioned in a center of the liquid hydrogen pipeline and immersed in liquid hydrogen inside the liquid hydrogen pipeline. The group of cable supporting members is positioned around the superconducting cable group to support the superconducting cable group inside of the liquid hydrogen pipeline. The internal insulation layer is positioned around an outside surface of the liquid hydrogen pipeline. The liquid nitrogen cold shield is positioned around an outside surface of the internal insulation layer. The external cold insulation layer is positioned around the liquid nitrogen cold shield.

In certain embodiments, the superconducting cable pipeline includes: a liquid nitrogen supply pipeline and a nitrogen recovery pipeline. The liquid nitrogen supply pipeline delivers low temperature liquid nitrogen to the liquid nitrogen cold shield through a liquid nitrogen pressure reducing valve. The nitrogen recovery pipeline recovers liquid nitrogen from the liquid nitrogen cold shield.

In certain embodiments, the superconducting cable pipeline includes: a nitrogen re-liquefier. The nitrogen re-liquefier recovers nitrogen from the nitrogen recovery pipeline, re-liquefies the nitrogen recovered and delivers re-liquefied nitrogen back to liquid nitrogen supply pipeline to maintain sufficient liquid nitrogen supply for the superconducting cable pipeline.

In certain embodiments, the superconducting cable pipeline includes: a first end and a second end. The first end is connected to a first liquid hydrogen storage container for supplying liquid hydrogen to the liquid hydrogen pipeline of the superconducting cable pipe of the superconducting cable pipeline. The second end is connected to a second liquid hydrogen storage container for supplying liquid hydrogen to the liquid hydrogen pipeline of the superconducting cable pipe of the superconducting cable pipeline.

In another aspect, the present disclosure relates to a superconducting liquid hydrogen energy pipeline system. In certain embodiments, the superconducting liquid hydrogen energy pipeline system includes: a superconducting liquid hydrogen energy pipeline starting station, one or more superconducting liquid hydrogen energy pipeline intermediate stations, a superconducting liquid hydrogen energy pipeline terminal station, and a group of superconducting cable pipelines connecting the superconducting liquid hydrogen energy pipeline starting station to the superconducting liquid hydrogen energy pipeline terminal station through the one or more superconducting liquid hydrogen energy pipeline intermediate stations.

In certain embodiments, the superconducting liquid hydrogen energy pipeline starting station converts an AC power to a first DC power and transmits the first DC power out of the superconducting liquid hydrogen energy pipeline starting station. Each of the one or more superconducting liquid hydrogen energy pipeline intermediate stations combines DC power received and DC power generated for transmission through a superconducting cable pipeline out of the superconducting liquid hydrogen energy pipeline intermediate station. The superconducting liquid hydrogen energy pipeline terminal station terminates the DC power transmission, inverts the DC power received to generate AC power, and delivers the AC power generated to an output to power grid at the superconducting liquid hydrogen energy pipeline terminal station.

In certain embodiments, the group of superconducting cable pipelines sequentially connects the superconducting liquid hydrogen energy pipeline starting station, the one or more superconducting liquid hydrogen energy pipeline intermediate stations, and the superconducting liquid hydrogen energy pipeline terminal station to transmit electrical power from the superconducting liquid hydrogen energy pipeline starting station to the superconducting liquid hydrogen energy pipeline terminal station.

In certain embodiments, the superconducting liquid hydrogen energy pipeline starting station includes: a first electrical power input rectifying station, and a first liquid hydrogen storage container. The first electrical power input rectifying station receives AC power from a first AC power source, and rectifies the AC power to a first DC power for transmission out of the superconducting liquid hydrogen energy pipeline starting station. The first liquid hydrogen storage container includes a power adapter configured to receive the first DC power through a normal temperature cable group outside of the first liquid hydrogen storage container, and a low temperature cable group inside of the first liquid hydrogen storage container, and transmit the first DC power out of the superconducting liquid hydrogen energy pipeline starting station through the group of superconducting cable pipelines.

In certain embodiments, the superconducting liquid hydrogen energy pipeline starting station includes: a water electrolysis device, and a hydrogen liquefier. The water electrolysis device receives clean water and generates oxygen and hydrogen. The hydrogen liquefier liquifies the hydrogen generated by the water electrolysis device to generate liquid hydrogen for the first liquid hydrogen storage container.

In certain embodiments, the superconducting cable pipeline is formed by connecting a group of superconducting cable pipes in sequence. Each of the group of superconducting cable pipes includes: a superconducting cable group, a liquid hydrogen pipeline, a group of cable supporting members, an internal insulation layer, a liquid nitrogen cold shield, and an external cold insulation layer. The superconducting cable group is used to transmit a DC power to a remote destination. The superconducting cable group is positioned in a center of the liquid hydrogen pipeline and immersed in liquid hydrogen inside the liquid hydrogen pipeline. The group of cable supporting members is positioned around the superconducting cable group to support the superconducting cable group inside of the liquid hydrogen pipeline. The internal insulation layer is positioned around an outside surface of the liquid hydrogen pipeline. The liquid nitrogen cold shield is positioned around an outside surface of the internal insulation layer. The external cold insulation layer is positioned around the liquid nitrogen cold shield.

In certain embodiments, the superconducting cable pipeline includes: a liquid nitrogen supply pipeline and a nitrogen recovery pipeline. The liquid nitrogen supply pipeline delivers low temperature liquid nitrogen to the liquid nitrogen cold shield through a liquid nitrogen pressure reducing valve. The nitrogen recovery pipeline recovers liquid nitrogen from the liquid nitrogen cold shield.

In certain embodiments, the superconducting cable pipeline includes: a nitrogen re-liquefier. The nitrogen re-liquefier recovers nitrogen from the nitrogen recovery pipeline, re-liquefies the nitrogen recovered and delivers re-liquefied nitrogen back to liquid nitrogen supply pipeline to maintain sufficient liquid nitrogen supply for the superconducting cable pipeline.

In certain embodiments, the superconducting cable pipeline includes: a first end and a second end. The first end is connected to the first liquid hydrogen storage container for supplying liquid hydrogen to the liquid hydrogen pipeline of the superconducting cable pipe of the superconducting cable pipeline. The second end is connected to a second liquid hydrogen storage container for supplying liquid hydrogen to the liquid hydrogen pipeline of the superconducting cable pipe of the superconducting cable pipeline.

In certain embodiments, each of the one or more superconducting liquid hydrogen energy pipeline intermediate stations includes: a second electrical power input rectifying station, the second liquid hydrogen storage container, and a third liquid hydrogen storage container. The second electrical power input rectifying station receives an AC power from a second AC power source, a second DC power from an input superconducting cable pipe through a first power adapter, low temperature cable group and a normal temperature cable group, and rectifies the AC power to a second DC power for transmission out of the superconducting liquid hydrogen energy pipeline intermediate station through a normal temperature cable group, low temperature cable group, a second power adapter and an output superconducting cable pipe. The second liquid hydrogen storage container includes the first power adapter connecting to the input superconducting cable pipe. The third liquid hydrogen storage container includes the second power adapter connecting to the output superconducting cable pipe.

In certain embodiments, each of the one or more superconducting liquid hydrogen energy pipeline intermediate stations includes: a liquid hydrogen pump, and a hydrogen re-liquefier. The liquid hydrogen pump connects the second liquid hydrogen storage container and the third liquid hydrogen storage container through pipelines. The hydrogen re-liquefier liquifies hydrogen from the second liquid hydrogen storage container to generate liquid hydrogen and delivers liquid hydrogen generated to the third liquid hydrogen storage container.

In certain embodiments, the superconducting liquid hydrogen energy pipeline terminal station includes: a fourth liquid hydrogen storage container, and an output power inverter station. The fourth liquid hydrogen storage container includes a power adapter configured to receive a DC power through a superconducting cable group and to transmit the DC power received through a low temperature cable group to an output power inverter station. The output power inverter station inverters the DC power to an AC power and delivers the AC power to the output to power grid.

In certain embodiments, the superconducting liquid hydrogen energy pipeline terminal station includes: a hydrogen heating pressurizer, a hydrogen power generator, and a liquid hydrogen pump. The hydrogen heating pressurizer heats and pressurizes liquid hydrogen from the fourth liquid hydrogen storage container to generate hydrogen and hydrogen output supply. The hydrogen power generator uses the hydrogen from the hydrogen heating pressurizer to generate a DC power and to transmit the DC power generated the output power inverter station. The liquid hydrogen pump pressurizes liquid hydrogen from the fourth liquid hydrogen storage container and generates liquid hydrogen output supply.

In yet another aspect, the present disclosure relates to a method of using a superconducting liquid hydrogen energy pipeline system. In certain embodiments, the method includes:
installing a superconducting liquid hydrogen energy pipeline starting station at a first AC power source;
installing a superconducting liquid hydrogen energy pipeline terminal station at a location where the AC power from the first AC power source is to be delivered;
installing a superconducting cable pipeline connecting the superconducting liquid hydrogen energy pipeline starting station and the superconducting liquid hydrogen energy pipeline terminal station, wherein the superconducting cable pipeline is configured to transmit a first DC power from the superconducting liquid hydrogen energy pipeline starting station to the superconducting liquid hydrogen energy pipeline terminal station;
electrolyzing, by a water electrolysis device at the superconducting liquid hydrogen energy pipeline starting station, clean water to generate oxygen and hydrogen, liquifying, by a hydrogen liquefier, the hydrogen to generate liquid hydrogen and delivering the liquid hydrogen generated to a first liquid hydrogen storage container for cooling the superconducting cable pipeline;
connecting the first AC power source to a first electrical power input rectifying station to rectify AC power from the first AC power source to generate the first DC power, and delivering the first DC power to a superconducting cable group of a superconducting cable pipe of the superconducting cable pipeline through a normal temperature cable group, a low temperature cable group, and a power adapter of the first liquid hydrogen storage container;
transmitting, the first DC power through the superconducting cable group of the superconducting cable pipe of the superconducting cable pipeline, to the superconducting cable group of the superconducting cable pipe of the superconducting cable pipeline of the superconducting liquid hydrogen energy pipeline terminal station through a power adapter of a fourth liquid hydrogen storage container, a low temperature cable group, and a normal temperature cable group; and
inverting, by an output power inverter station of the superconducting liquid hydrogen energy pipeline terminal station, a DC power received to AC power, and delivering the AC power to an output to power grid.

In certain embodiments, the superconducting cable pipeline is formed by connecting a group of superconducting cable pipes in sequence. Each of the group of superconducting cable pipes includes: a superconducting cable group, a liquid hydrogen pipeline, a group of cable supporting members, an internal insulation layer, a liquid nitrogen cold shield, and an external cold insulation layer. The superconducting cable group is used to transmit DC power to a remote destination. The superconducting cable group is positioned in a center of the liquid hydrogen pipeline and immersed in liquid hydrogen inside the liquid hydrogen pipeline. The group of cable supporting members is positioned around the superconducting cable group to support the superconducting cable group inside of the liquid hydrogen pipeline. The internal insulation layer is positioned around an outside surface of the liquid hydrogen pipeline. The liquid nitrogen cold shield is positioned around an outside surface of the internal insulation layer. The external cold insulation layer is positioned around the liquid nitrogen cold shield.

In certain embodiments, the method includes: installing one or more superconducting liquid hydrogen energy pipeline intermediate stations, between the superconducting liquid hydrogen energy pipeline starting station and superconducting liquid hydrogen energy pipeline terminal station to extend transmission distance of the superconducting liquid hydrogen energy pipeline system.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the present disclosure, and features and benefits thereof, and together with the written description, serve to explain the principles of the present invention. Wherever possible, the same reference numbers are used throughout the drawings to refer to the same or like elements of an embodiment, and wherein:

FIG. 1 shows a cross-section view of structure diagram of a superconducting cable pipeline according to certain embodiments of the present disclosure;

FIG. 2 shows a longitudinal sectional view of the superconducting cable pipeline according to certain embodiments of the present disclosure;

FIG. 3 illustrates the superconducting cable pipeline positioned between a first liquid hydrogen storage container and a second liquid hydrogen storage container according to certain embodiments of the present disclosure;

FIG. 4 illustrates a structure diagram of a superconducting liquid hydrogen energy pipeline system according to certain embodiments of the present disclosure;

FIG. 5 illustrates a detailed structure diagram of the superconducting liquid hydrogen energy pipeline system according to certain embodiments of the present disclosure; and

FIG. 6 shows a method of using the superconducting liquid hydrogen energy pipeline system according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or conconventionally) without altering the principles of the present disclosure.

The present disclosure will now be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

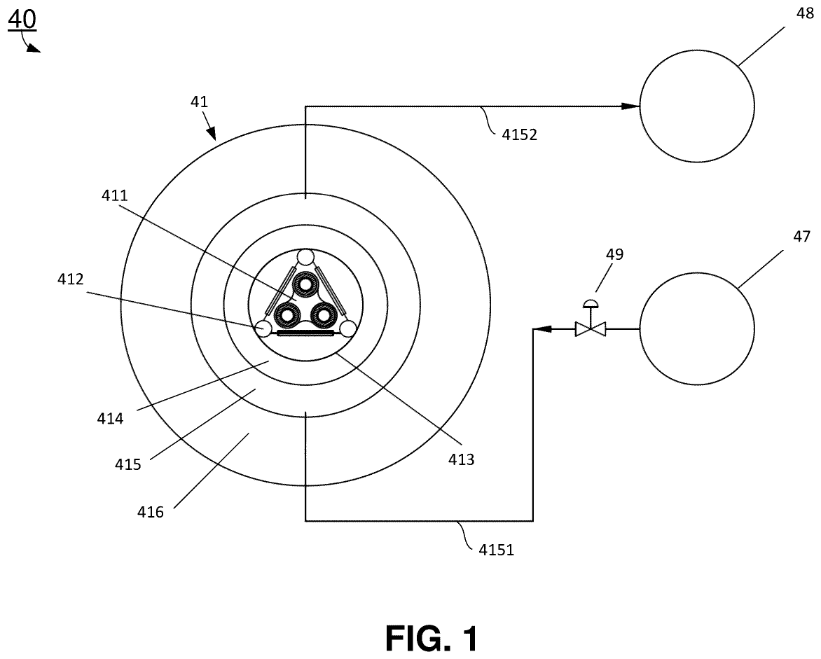

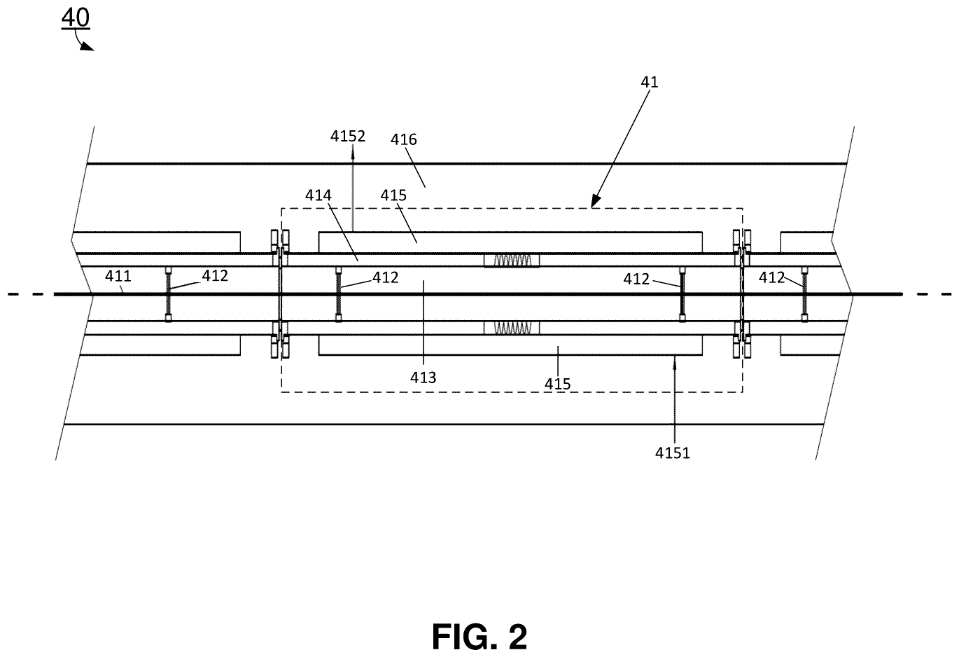

Referring now to FIGS. 1-5, in one aspect, the present disclosure relates to a superconducting cable pipeline 40. In certain embodiments, as shown in FIG. 2, the superconducting cable pipeline 40 is formed by connecting a group of superconducting cable pipes 41 in sequence. As shown in FIG. 1, each of the group of superconducting cable pipes 41 includes: a superconducting cable group 411 having multiple superconducting cables, a liquid hydrogen pipeline 413 filled with liquid hydrogen, a group of cable supporting members 412 supporting the superconducting cable group 411 inside the liquid hydrogen pipeline 413, an internal insulation layer 414, a liquid nitrogen cold shield 415, and an external cold insulation layer 416. The superconducting cable group 411 is used to transmit a DC power to a remote destination. The superconducting cable group 411 is positioned in a center of the liquid hydrogen pipeline 413 and immersed in liquid hydrogen inside the liquid hydrogen pipeline 413. The group of cable supporting members 412 is positioned around the superconducting cable group 411 to support the superconducting cable group 411 inside of the liquid hydrogen pipeline 413. The internal insulation layer 414 is positioned around an outside surface of the liquid hydrogen pipeline 413 to insulate the liquid hydrogen pipeline 413. The liquid nitrogen cold shield 415 is positioned around an outside surface of the internal insulation layer 414 to provide cooling from liquid nitrogen. The external cold insulation layer 416 is positioned around the liquid nitrogen cold shield 415 to further insulate the liquid nitrogen cold shield 415.

In certain embodiments, as shown in FIG. 1, the superconducting cable pipeline 40 includes: a liquid nitrogen supply pipeline 47 and a nitrogen recovery pipeline 48. The liquid nitrogen supply pipeline 47 delivers low temperature liquid nitrogen 4151 to the liquid nitrogen cold shield 415 through a liquid nitrogen pressure reducing valve 49. The nitrogen recovery pipeline 48 recovers liquid nitrogen 4152 from the liquid nitrogen cold shield 415.

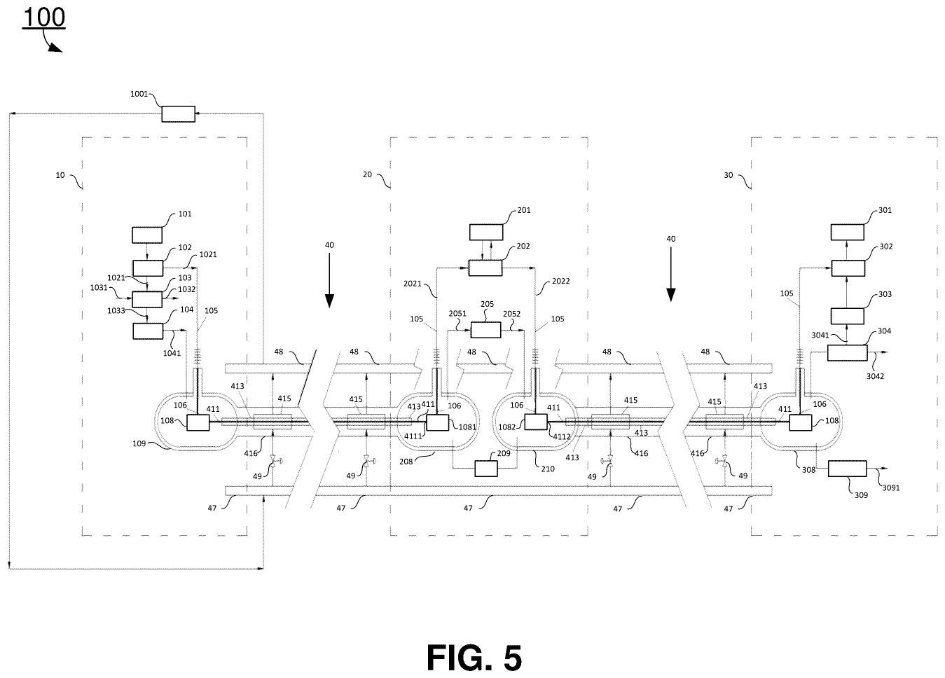

In certain embodiments, as shown in FIG. 5, the superconducting cable pipeline 40 includes: a nitrogen re-liquefier 1001. The nitrogen re-liquefier 1001 recovers nitrogen from the nitrogen recovery pipeline 48, re-liquefies the nitrogen recovered and delivers re-liquefied nitrogen back to the liquid nitrogen supply pipeline 47 to maintain sufficient liquid nitrogen supply for the superconducting cable pipeline 40.

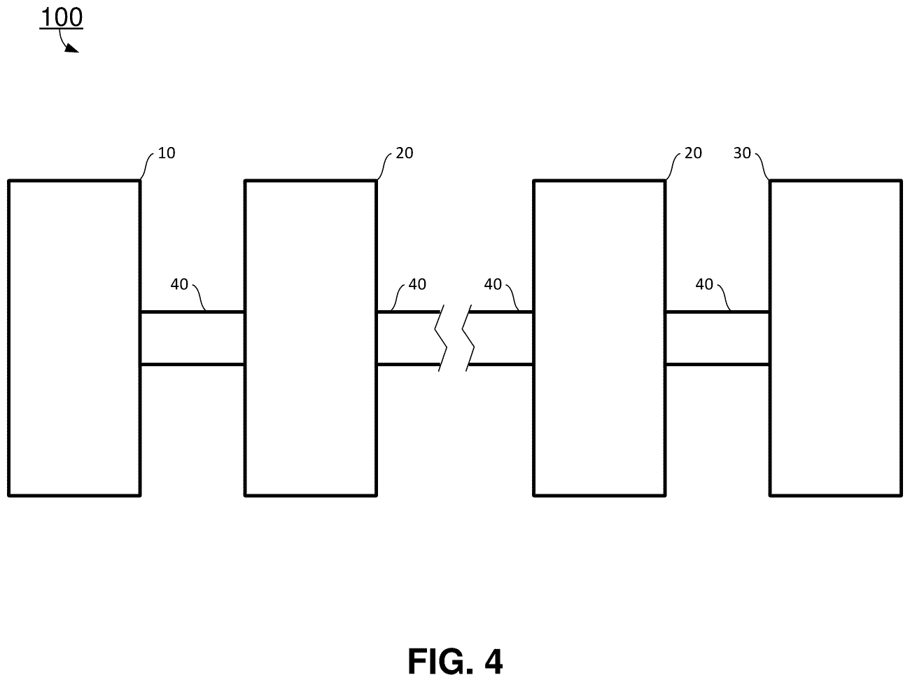

In certain embodiments, as shown in FIG. 4, the superconducting cable pipeline 40 includes: a first end 42 and a second end 43. The first end 42 is connected to a first liquid hydrogen storage container 109 for supplying liquid hydrogen to the liquid hydrogen pipeline 413 of the superconducting cable pipe 41 of the superconducting cable pipeline 40. The second end 43 is connected to a second liquid hydrogen storage container 208 for supplying liquid hydrogen to the liquid hydrogen pipeline 413 of the superconducting cable pipe 41 of the superconducting cable pipeline 40.

In another aspect, the present disclosure relates to a superconducting liquid hydrogen energy pipeline system 100. In certain embodiments, as shown in FIG. 4, the superconducting liquid hydrogen energy pipeline system 100 includes: a superconducting liquid hydrogen energy pipeline starting station 10, one or more superconducting liquid hydrogen energy pipeline intermediate stations 20, a superconducting liquid hydrogen energy pipeline terminal station 30, and a group of superconducting cable pipelines 40 connecting the superconducting liquid hydrogen energy pipeline starting station 10 to the superconducting liquid hydrogen energy pipeline terminal station 30 through the one or more superconducting liquid hydrogen energy pipeline intermediate stations 20.

In certain embodiments, as shown in FIG. 5, the superconducting liquid hydrogen energy pipeline starting station 10 converts an AC power to a DC power and transmits the DC power out of the superconducting liquid hydrogen energy pipeline starting station 10. Each of the one or more superconducting liquid hydrogen energy pipeline intermediate station 20 combines DC power received and DC power generated for transmission through a superconducting cable pipeline 40 out of the superconducting liquid hydrogen energy pipeline intermediate station 20. The superconducting liquid hydrogen energy pipeline terminal station 30 terminates the DC power transmission, inverts the DC power received to generate AC power, and delivers the AC power generated to an output to power grid 301 at the superconducting liquid hydrogen energy pipeline terminal station 30.

In certain embodiments, as shown in FIGS. 4-5, the group of superconducting cable pipelines 40 sequentially connects the superconducting liquid hydrogen energy pipeline starting station 10, the one or more superconducting liquid hydrogen energy pipeline intermediate stations 20, and the superconducting liquid hydrogen energy pipeline terminal station 30 to transmit electrical power from the superconducting liquid hydrogen energy pipeline starting station 10 to the superconducting liquid hydrogen energy pipeline terminal station 30.

In certain embodiments, as shown in FIG. 5, the superconducting liquid hydrogen energy pipeline starting station 10 includes: a first electrical power input rectifying station 102, and a first liquid hydrogen storage container 109. The superconducting liquid hydrogen energy pipeline starting station 10 is connected to a first AC power source 101, and the first AC power source 101 provides the electrical power to be transmitted out of the superconducting liquid hydrogen energy pipeline starting station 10. In certain embodiments, the first AC power source 101 includes electrical power generated in traditional forms such as fossil fuel power plants, nuclear power plants etc., as well as from many different kind of renewable energy sources, such as, solar farms, wind farms, hydropower stations, ocean energy stations, geothermal energy stations, biomass stations, and hydrogen fuel stations.

In certain embodiments, as shown in FIG. 5, the first electrical power input rectifying station 102 receives AC power from the first AC power source 101, and rectifies the AC power to a DC power 1021 for transmission out of the superconducting liquid hydrogen energy pipeline starting station 10. The first liquid hydrogen storage container 109 includes a power adapter 108 configured to receive the DC power 1021 through a normal temperature cable group 105 outside of the first liquid hydrogen storage container 109, and a low temperature cable group 106 inside of the first liquid hydrogen storage container 109, and transmit the DC power 1021 out of the superconducting liquid hydrogen energy pipeline starting station 10 through a superconducting cable group 411 of a superconducting cable pipe 41 of a superconducting cable pipeline 40.

In certain embodiments, the superconducting liquid hydrogen energy pipeline starting station 10 includes: a water electrolysis device 103, and a hydrogen liquefier 104. The water electrolysis device 103 receives clean water 1031 and generates oxygen 1032 and hydrogen 1033. The hydrogen liquefier 104 liquifies the hydrogen 1033 generated by the water electrolysis device 103 to generate liquid hydrogen 1041 for the first liquid hydrogen storage container 109. In one embodiment, the liquid hydrogen 1041 generated can be used for cooling the superconducting cable group 411 inside a liquid hydrogen pipeline 413 of the superconducting cable pipe 41. In another embodiment, the liquid hydrogen 1041 generated can be used for generating electrical power at a hydrogen fuel station. A by-product of the water electrolysis device 103 is oxygen, which can be used for other purposes such as: melting, refining and manufacture of steel and other metals; manufacture of chemicals by controlled oxidation; rocket propulsion; medical and biological life support; and mining, production and manufacture of stone and glass products.

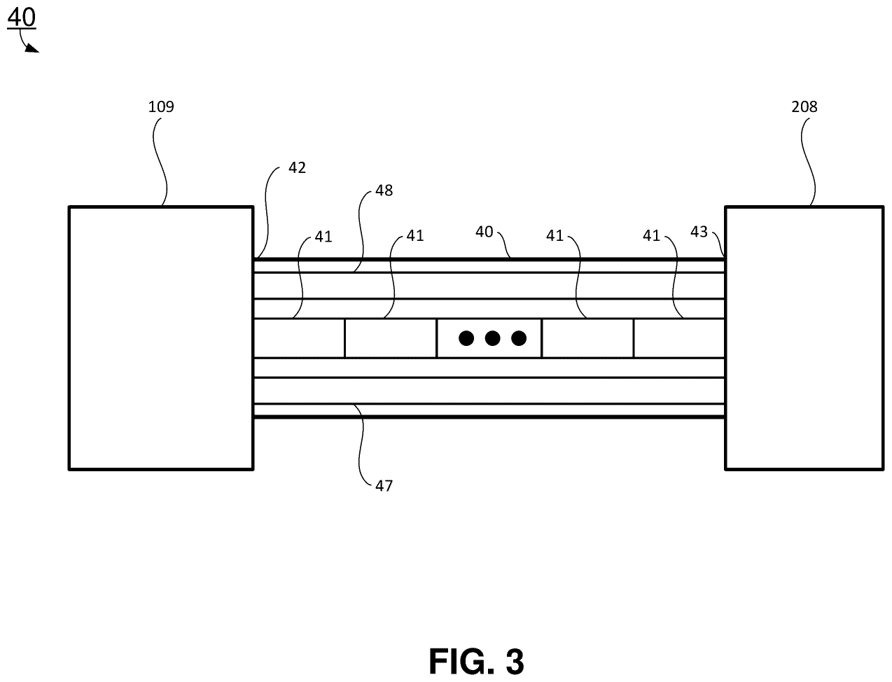

In certain embodiments, as shown in FIG. 3, the superconducting cable pipeline 40 is formed by connecting a group of superconducting cable pipes 41 in sequence. As shown in FIG. 1 and FIG. 2, each of the group of superconducting cable pipes 41 includes: a superconducting cable group 411, a liquid hydrogen pipeline 413, a group of cable supporting members 412, an internal insulation layer 414, a liquid nitrogen cold shield 415, and an external cold insulation layer 416. The superconducting cable group 411 is used to transmit a DC power to a remote destination. The superconducting cable group 411 is positioned in a center of the liquid hydrogen pipeline 413 and immersed in liquid hydrogen inside the liquid hydrogen pipeline 413. The group of cable supporting members 412 is positioned around the superconducting cable group 411 to support the superconducting cable group 411 inside of the liquid hydrogen pipeline 413. The internal insulation layer 414 is positioned around an outside surface of the liquid hydrogen pipeline 413 to provide heat insulation to the liquid hydrogen pipeline 413. The liquid nitrogen cold shield 415 is positioned around an outside surface of the internal insulation layer 414 and used for further cooling the liquid hydrogen pipeline 413 using liquid nitrogen. The external cold insulation layer 416 is positioned around the liquid nitrogen cold shield 415 to provide additional heat insulation for the superconducting cable pipe 41.

In certain embodiments, as shown in FIG. 1, the superconducting cable pipeline 40 includes: a liquid nitrogen supply pipeline 47 and a nitrogen recovery pipeline 48. The liquid nitrogen supply pipeline 47 delivers low temperature liquid nitrogen 4151 to the liquid nitrogen cold shield 415 through a liquid nitrogen pressure reducing valve 49. The nitrogen recovery pipeline 48 recovers liquid nitrogen 4152 from the liquid nitrogen cold shield 415.

In certain embodiments, as shown in FIG. 5, the superconducting cable pipeline 40 includes: a nitrogen re-liquefier 1001. The nitrogen re-liquefier 1001 recovers nitrogen from the nitrogen recovery pipeline 48, re-liquefies the nitrogen recovered and delivers re-liquefied nitrogen back to liquid nitrogen supply pipeline 47 to maintain sufficient liquid nitrogen supply for the superconducting cable pipe 41 of the superconducting cable pipeline 40.

In certain embodiments, as shown in FIG. 3, the superconducting cable pipeline 40 includes: a first end 42 and a second end 43. The first end 42 is connected to the first liquid hydrogen storage container 109 for supplying liquid hydrogen to the liquid hydrogen pipeline 413 of the superconducting cable pipe 41 of the superconducting cable pipeline 40. The second end 43 is connected to a second liquid hydrogen storage container 208 for supplying liquid hydrogen to the liquid hydrogen pipeline 413 of the superconducting cable pipe 41 of the superconducting cable pipeline 40.

In certain embodiments, as shown in FIG. 5, each of the one or more superconducting liquid hydrogen energy pipeline intermediate stations 20 includes: a second electrical power input rectifying station 202, a second liquid hydrogen storage container 208, and a third liquid hydrogen storage container 210. In certain embodiments, the second liquid hydrogen storage container 208 is an input terminal of the superconducting liquid hydrogen energy pipeline intermediate station 20, and the third liquid hydrogen storage container 210 is an output terminal of the superconducting liquid hydrogen energy pipeline intermediate station 20. The input terminal of the superconducting liquid hydrogen energy pipeline intermediate station 20 includes an input superconducting cable pipe 4111 connecting to a superconducting cable group 411 of the superconducting cable pipe 41 of the superconducting cable pipeline 40 as an input to the superconducting liquid hydrogen energy pipeline intermediate station 20, a first power adapter 1081, a low temperature cable group 106 and a normal temperature cable group 105. The output terminal of the superconducting liquid hydrogen energy pipeline intermediate station 20 includes an output superconducting cable pipe 4112 connecting to a superconducting cable group 411 of the superconducting cable pipe 41 of the superconducting cable pipeline 40 connecting to the superconducting liquid hydrogen energy pipeline intermediate station 20 as an output of the superconducting liquid hydrogen energy pipeline intermediate station 20, a second power adapter 1082, a low temperature cable group 106 and a normal temperature cable group 105.

In certain embodiments, the superconducting liquid hydrogen energy pipeline intermediate station 20 may connect to a second AC power source 201 to collect additional AC power sources. In certain embodiments, the second AC power source 201 includes electrical power generated in traditional forms such as fossil fuel power plants, nuclear power plants etc., as well as from many different kind of renewable energy sources, such as, solar farms, wind farms, hydropower stations, ocean energy stations, geothermal energy stations, biomass stations, and hydrogen fuel stations.

In certain embodiments, as shown in FIG. 5, an input DC power 2021 from the input terminal of the superconducting liquid hydrogen energy pipeline intermediate station 20 is connected to the second electrical power input rectifying station 202. The second AC power source 201 may also connect to the second electrical power input rectifying station 202. An output DC power 2022 includes: the input DC power 2021 from the input terminal of the superconducting liquid hydrogen energy pipeline intermediate station 20, and the DC power rectified by the second electrical power input rectifying station 202 from the AC power received from the second AC power source 201. The output DC power 2022 is delivered to the output terminal of the superconducting liquid hydrogen energy pipeline intermediate station 20.

In certain embodiments, each of the one or more superconducting liquid hydrogen energy pipeline intermediate stations 20 includes: a liquid hydrogen pump 209, and a hydrogen re-liquefier 205. The liquid hydrogen pump 209 connects the second liquid hydrogen storage container 208 and the third liquid hydrogen storage container 210 through pipelines. The hydrogen re-liquefier 205 liquifies hydrogen 2051 from the second liquid hydrogen storage container 208 to generate liquid hydrogen 2052 and delivers liquid hydrogen 2052 generated to the third liquid hydrogen storage container 210.

In certain embodiments, the superconducting liquid hydrogen energy pipeline terminal station 30 includes: a fourth liquid hydrogen storage container 308, and an output power inverter station 302. The fourth liquid hydrogen storage container 308 includes a power adapter 108 configured to receive DC power through a superconducting cable group 411 of a superconducting cable pipe 41 of a superconducting cable pipeline 40, and to transmit the DC power received through a low temperature cable group 106 and a normal temperature cable group 105 to the output power inverter station 302. The output power inverter station 302 inverters DC power to an AC power and delivers the AC power to output to power grid 301.

In certain embodiments, as shown in FIG. 5, the superconducting liquid hydrogen energy pipeline terminal station 30 includes: a hydrogen heating pressurizer 304, a hydrogen power generator 303, and a liquid hydrogen pump 309. The hydrogen heating pressurizer 304 heats and pressurizes liquid hydrogen from the fourth liquid hydrogen storage container 308 to generate hydrogen 3041 and hydrogen output supply 3042. The hydrogen power generator 303 uses the hydrogen 3041 from the hydrogen heating pressurizer 304 to generate DC power and to transmit the DC power generated the output power inverter station 302. The liquid hydrogen pump 309 pressurizes liquid hydrogen from the fourth liquid hydrogen storage container 308 and generates liquid hydrogen output supply 3091.

In yet another aspect, the present disclosure relates to a method of using a superconducting liquid hydrogen energy pipeline system 100. In certain embodiments, the method includes:
installing a superconducting liquid hydrogen energy pipeline starting station 10 at a first AC power source 101;
installing a superconducting liquid hydrogen energy pipeline terminal station 30 at a location where the AC power from the first AC power source 101 is to be delivered;
installing a superconducting cable pipeline 40 connecting the superconducting liquid hydrogen energy pipeline starting station 10 and the superconducting liquid hydrogen energy pipeline terminal station 30, the superconducting cable pipeline 40 is configured to transmit the DC power from the superconducting liquid hydrogen energy pipeline starting station 10 to the superconducting liquid hydrogen energy pipeline terminal station 30;
electrolyzing, by a water electrolysis device at the superconducting liquid hydrogen energy pipeline starting station 10, clean water 1031 to generate oxygen 1032 and hydrogen 1033, liquifying, by a hydrogen liquefier 104, the hydrogen 1033 to generate liquid hydrogen 1041, and delivering the liquid hydrogen 1041 generated to a first liquid hydrogen storage container 109 for cooling the superconducting cable pipeline 40;
connecting the first AC power source 101 to a first electrical power input rectifying station 102 to rectify AC power from the first AC power source 101 to generate a DC power 1021, and delivering the DC power 1021 to a superconducting cable group 411 of a superconducting cable pipe 41 of the superconducting cable pipeline 40 through a normal temperature cable group 105, a low temperature cable group 106, and a power adapter 108 of the first liquid hydrogen storage container 109;
transmitting, the DC power through the superconducting cable group 411 of the superconducting cable pipe 41 of the superconducting cable pipeline 40, to the superconducting cable group 411 of the superconducting cable pipe 41 of the superconducting cable pipeline 40 of the superconducting liquid hydrogen energy pipeline terminal station 30 through a power adapter 108 of a fourth liquid hydrogen storage container 308, a low temperature cable group 106, and a normal temperature cable group 105; and
inverting, by an output power inverter station 302 of the superconducting liquid hydrogen energy pipeline terminal station 30, the DC power received to AC power, and delivering the AC power to output to power grid 301.

In certain embodiments, the method includes: installing one or more superconducting liquid hydrogen energy pipeline intermediate stations 20 between the superconducting liquid hydrogen energy pipeline starting station 10 and the superconducting liquid hydrogen energy pipeline terminal station 30, and connecting the superconducting liquid hydrogen energy pipeline starting station 10 and the superconducting liquid hydrogen energy pipeline terminal station 30 through the superconducting cable pipeline 40 to extend transmission distance of the superconducting liquid hydrogen energy pipeline system 100.

In certain embodiments, the superconducting cable pipeline 40 is formed by connecting a group of superconducting cable pipes 41 in sequence. Each of the group of superconducting cable pipes 41 includes: a superconducting cable group 411, a liquid hydrogen pipeline 413, a group of cable supporting members 412, an internal insulation layer 414, a liquid nitrogen cold shield 415, and an external cold insulation layer 416. The superconducting cable group 411 is used to transmit a DC power to a remote destination. The superconducting cable group 411 is positioned in a center of the liquid hydrogen pipeline 413 and immersed in liquid hydrogen inside the liquid hydrogen pipeline 413. The group of cable supporting members 412 is positioned around the superconducting cable group 411 to support the superconducting cable group 411 inside of the liquid hydrogen pipeline 413. The internal insulation layer 414 is positioned around an outside surface of the liquid hydrogen pipeline 413. The liquid nitrogen cold shield 415 is positioned around an outside surface of the internal insulation layer 414. The external cold insulation layer 416 is positioned around the liquid nitrogen cold shield 415.

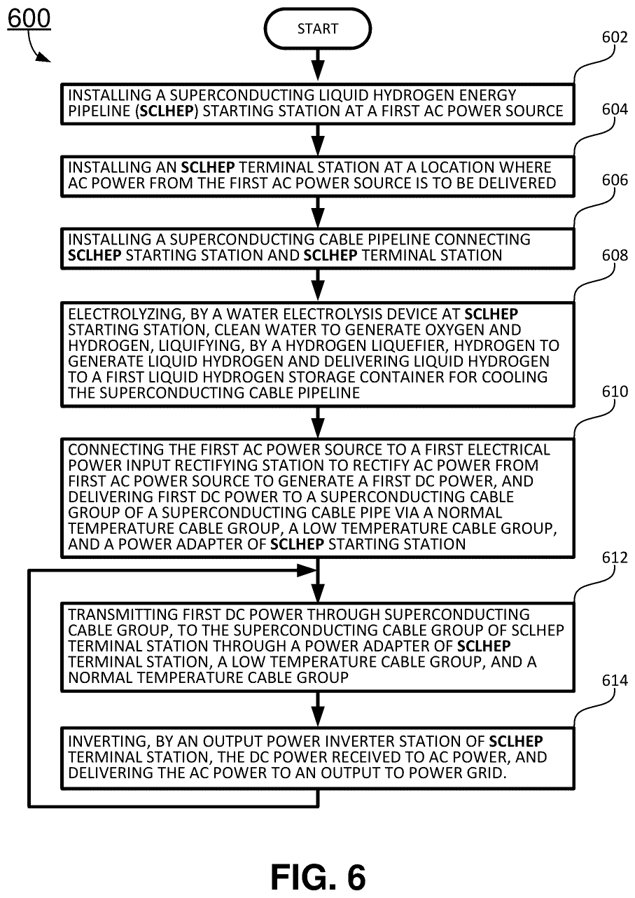

Referring now to FIG. 6, a method 600 of using a superconducting liquid hydrogen energy pipeline system 100 is shown according to certain embodiments of the present disclosure.

At block 602, installing a superconducting liquid hydrogen energy pipeline starting station 10 at a first AC power source 101. This is a starting point of the superconducting liquid hydrogen energy pipeline system 100.

At block 604, installing a superconducting liquid hydrogen energy pipeline terminal station 30 at a location where the AC power from the first AC power source 101 is to be delivered. This is a terminal point of the superconducting liquid hydrogen energy pipeline system 100.

At block 606, installing a superconducting cable pipeline 40 connecting the superconducting liquid hydrogen energy pipeline starting station 10 and the superconducting liquid hydrogen energy pipeline terminal station 30, the superconducting cable pipeline 40 is configured to transmit the DC power from the superconducting liquid hydrogen energy pipeline starting station 10 to the superconducting liquid hydrogen energy pipeline terminal station 30.

At block 608, electrolyzing, by a water electrolysis device 103 at the superconducting liquid hydrogen energy pipeline starting station 10, clean water 1031 to generate oxygen 1032 and hydrogen 1033, liquifying, by a hydrogen liquefier 104, the hydrogen 1033 to generate liquid hydrogen 1041, and delivering the liquid hydrogen 1041 generated to a first liquid hydrogen storage container 109 for cooling the superconducting cable pipeline 40.

At block 610, connecting the first AC power source 101 to a first electrical power input rectifying station 102 to rectify AC power from the first AC power source 101 to generate a DC power 1021, and delivering the DC power 1021 to a superconducting cable group 411 of a superconducting cable pipe 41 of the superconducting cable pipeline 40 through a normal temperature cable group 105, a low temperature cable group 106, and a power adapter 108 of the first liquid hydrogen storage container 109.

At block 612, transmitting, the DC power through the superconducting cable group 411 of the superconducting cable pipe 41 of the superconducting cable pipeline 40, to the superconducting cable group 411 of the superconducting cable pipe 41 of the superconducting cable pipeline 40 of the superconducting liquid hydrogen energy pipeline terminal station 30 through a power adapter 108 of a fourth liquid hydrogen storage container 308, a low temperature cable group 106, and a normal temperature cable group 105.

At block 614, inverting, by an output power inverter station 302 of the superconducting liquid hydrogen energy pipeline terminal station 30, the DC power received to AC power, and delivering the AC power to output to power grid 301.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A superconducting cable pipeline, comprises:
a plurality of superconducting cable pipes, wherein each of the plurality of superconducting cable pipes comprises:
a superconducting cable group, wherein superconducting cable group is used to transmit a DC power;
a liquid hydrogen pipeline, wherein the superconducting cable group is positioned in a center of the liquid hydrogen pipeline and immersed in liquid hydrogen inside the liquid hydrogen pipeline;
a plurality of cable supporting members, wherein the plurality of cable supporting members is positioned around the superconducting cable group to support the superconducting cable group inside of the liquid hydrogen pipeline;
an internal insulation layer, wherein the internal insulation layer is positioned around an outside surface of the liquid hydrogen pipeline;
a liquid nitrogen cold shield, wherein the liquid nitrogen cold shield is positioned around an outside surface of the internal insulation layer; and
an external cold insulation layer, wherein external cold insulation layer is positioned around the liquid nitrogen cold shield.

2. The superconducting cable pipeline according to claim 1, wherein the superconducting cable pipeline is formed by connecting the plurality of superconducting cable pipes in sequence.

3. The superconducting cable pipeline according to claim 2, wherein the superconducting cable pipeline comprises:
a liquid nitrogen supply pipeline, wherein the liquid nitrogen supply pipeline delivers low temperature liquid nitrogen to the liquid nitrogen cold shield through a liquid nitrogen pressure reducing valve; and
a nitrogen recovery pipeline, wherein the nitrogen recovery pipeline recovers liquid nitrogen from the liquid nitrogen cold shield.

4. The superconducting cable pipeline according to claim 3, wherein the superconducting cable pipeline comprises:
a nitrogen re-liquefier, wherein the nitrogen re-liquefier liquifies nitrogen recovered from the nitrogen recovery pipeline, and pump back to liquid nitrogen supply pipeline to maintain sufficient liquid nitrogen supply for the superconducting cable pipeline.

5. The superconducting cable pipeline according to claim 4, wherein the superconducting cable pipeline comprises:
a first end, wherein the first end is connected to a first liquid hydrogen storage container for supplying liquid hydrogen to the liquid hydrogen pipeline of a superconducting cable pipe of the superconducting cable pipeline;
and a second end, wherein the second end is connected to a second liquid hydrogen storage container for supplying liquid hydrogen to the liquid hydrogen pipeline of the superconducting cable pipe of the superconducting cable pipeline.

6. A superconducting liquid hydrogen energy pipeline system, comprises:
a superconducting liquid hydrogen energy pipeline starting station, wherein the superconducting liquid hydrogen energy pipeline starting station prepares a first DC power to be transmitted out of the superconducting liquid hydrogen energy pipeline starting station;
one or more superconducting liquid hydrogen energy pipeline intermediate stations, wherein each superconducting liquid hydrogen energy pipeline intermediate station combines the first DC power received and a DC power generated for transmission through an output superconducting cable pipeline out of the superconducting liquid hydrogen energy pipeline intermediate station;
a superconducting liquid hydrogen energy pipeline terminal station, wherein the superconducting liquid hydrogen energy pipeline terminal station terminates the DC power transmission, inverts a DC power received to generate AC power, and delivers the AC power generated to an output to power grid at the superconducting liquid hydrogen energy pipeline terminal station; and
a plurality of superconducting cable pipelines, wherein the plurality of superconducting cable pipelines sequentially connects the superconducting liquid hydrogen energy pipeline starting station, the one or more superconducting liquid hydrogen energy pipeline intermediate stations, and the superconducting liquid hydrogen energy pipeline terminal station to transmit electrical power from the superconducting liquid hydrogen energy pipeline starting station to the superconducting liquid hydrogen energy pipeline terminal station.

7. The superconducting liquid hydrogen energy pipeline system according to claim 6, wherein the superconducting liquid hydrogen energy pipeline starting station comprises:
a first electrical power input rectifying station, wherein the electrical power input rectifying station receives AC power from a first AC power source, and rectifies the AC power to the first DC power for transmission out of the superconducting liquid hydrogen energy pipeline starting station; and
a first liquid hydrogen storage container, wherein the first liquid hydrogen storage container comprises a power adapter configured to receive the first DC power through a normal temperature cable group outside of the first liquid hydrogen storage container, and a low temperature cable group inside of the first liquid hydrogen storage container, and transmit the first DC power out of the superconducting liquid hydrogen energy pipeline starting station through the plurality of superconducting cable pipelines.

8. The superconducting liquid hydrogen energy pipeline system according to claim 7, wherein the superconducting liquid hydrogen energy pipeline starting station comprises:
a water electrolysis device, wherein the water electrolysis device receives clean water and generates oxygen and hydrogen; and
a hydrogen liquefier, wherein the hydrogen liquefier liquifies the hydrogen to generate liquid hydrogen for the first liquid hydrogen storage container.

9. The superconducting liquid hydrogen energy pipeline system according to claim 6, wherein each of the plurality of superconducting cable pipelines comprises:
a plurality of superconducting cable pipe, wherein each of the plurality of superconducting cable pipes comprises:
a superconducting cable group, wherein superconducting cable group is used to transmit a DC power;
a liquid hydrogen pipeline, wherein the superconducting cable group is positioned in a center of the liquid hydrogen pipeline and immersed in liquid hydrogen inside the liquid hydrogen pipeline;
a plurality of cable supporting members, wherein the plurality of cable supporting members is positioned around the superconducting cable group to support the superconducting cable group inside of the liquid hydrogen pipeline;
an internal insulation layer, wherein the internal insulation layer is positioned around an outside surface of the liquid hydrogen pipeline;
a liquid nitrogen cold shield, wherein the liquid nitrogen cold shield is positioned around an outside surface of the internal insulation layer; and
an external cold insulation layer, wherein external cold insulation layer is positioned around the liquid nitrogen cold shield.

10. The superconducting liquid hydrogen energy pipeline system according to claim 9, wherein each of the plurality of superconducting cable pipelines is formed by connecting the plurality of superconducting cable pipes in sequence.

11. The superconducting liquid hydrogen energy pipeline system according to claim 10, wherein each of the plurality of superconducting cable pipelines comprises:
a liquid nitrogen supply pipeline, wherein the liquid nitrogen supply pipeline delivers low temperature liquid nitrogen to the liquid nitrogen cold shield through a liquid nitrogen pressure reducing valve; and
a nitrogen recovery pipeline, wherein the nitrogen recovery pipeline recovers liquid nitrogen from the liquid nitrogen cold shield.

12. The superconducting liquid hydrogen energy pipeline system according to claim 11, wherein the superconducting cable pipeline comprises:
a nitrogen re-liquefier, wherein the nitrogen re-liquefier recovers nitrogen from the nitrogen recovery pipeline, re-liquefies the nitrogen recovered and delivers re-liquefied nitrogen back to liquid nitrogen supply pipeline to maintain sufficient liquid nitrogen supply for the superconducting cable pipeline.

13. The superconducting liquid hydrogen energy pipeline system according to claim 12, wherein each of the plurality of superconducting cable pipelines comprises:
a first end, wherein the first end is connected to a first liquid hydrogen storage container for supplying liquid hydrogen to the liquid hydrogen pipeline of a superconducting cable pipe of the superconducting cable pipeline;
and a second end, wherein the second end is connected to a second liquid hydrogen storage container for supplying liquid hydrogen to the liquid hydrogen pipeline of the superconducting cable pipe of the superconducting cable pipeline.

14. The superconducting liquid hydrogen energy pipeline system according to claim 6, wherein each of the one or more superconducting liquid hydrogen energy pipeline intermediate stations comprises:
a second electrical power input rectifying station, wherein the second electrical power input rectifying station receives an AC power from a second AC power source, a DC power from an input superconducting cable pipe through a first power adapter, low temperature cable group and a normal temperature cable group, and rectifies an AC power to a second DC power for transmission out of the superconducting liquid hydrogen energy pipeline intermediate station through a normal temperature cable group, low temperature cable group, a second power adapter and an output superconducting cable pipe;
a second liquid hydrogen storage container, wherein the second liquid hydrogen storage container includes the first power adapter connecting to the input superconducting cable pipe; and
a third liquid hydrogen storage container, wherein the third liquid hydrogen storage container includes the second power adapter connecting to the output superconducting cable pipe.

15. The superconducting liquid hydrogen energy pipeline system according to claim 14, wherein each of the one or more superconducting liquid hydrogen energy pipeline intermediate stations comprises:
a liquid hydrogen pump, wherein the liquid hydrogen pump connects the second liquid hydrogen storage container and the third liquid hydrogen storage container through pipelines; and
a hydrogen re-liquefier, wherein the hydrogen re-liquefier liquifies hydrogen from the second liquid hydrogen storage container to generate liquid hydrogen and delivers liquid hydrogen generated to the third liquid hydrogen storage container.

16. The superconducting liquid hydrogen energy pipeline system according to claim 6, wherein the superconducting liquid hydrogen energy pipeline terminal station comprises:
a fourth liquid hydrogen storage container, wherein the fourth liquid hydrogen storage container includes a power adapter configured to receive a DC power through a superconducting cable group and to transmit the DC power received through a low temperature cable group to an output power inverter station; and
the output power inverter station, wherein the output power inverter station inverters DC power to AC power and delivers the AC power to the output to power grid.

17. The superconducting liquid hydrogen energy pipeline system according to claim 16, wherein the superconducting liquid hydrogen energy pipeline terminal station comprises:
a hydrogen heating pressurizer, wherein the hydrogen heating pressurizer heats and pressurizes liquid hydrogen from the fourth liquid hydrogen storage container to generate hydrogen and hydrogen output supply;
a hydrogen power generator, wherein the hydrogen power generator uses the hydrogen from the hydrogen heating pressurizer to generate a DC power and to transmit the DC power generated the output power inverter station; and
a liquid hydrogen pump, wherein the liquid hydrogen pump pressurizes liquid hydrogen from the fourth liquid hydrogen storage container and generates liquid hydrogen output supply.

18. A method of using a superconducting liquid hydrogen energy pipeline system, comprising:
installing a superconducting liquid hydrogen energy pipeline starting station at a first AC power source;
installing a superconducting liquid hydrogen energy pipeline terminal station at a location where the AC power from the first AC power source is to be delivered;
installing a superconducting cable pipeline connecting the superconducting liquid hydrogen energy pipeline starting station and the superconducting liquid hydrogen energy pipeline terminal station, wherein the superconducting cable pipeline is configured to transmit a first DC power from the superconducting liquid hydrogen energy pipeline starting station to the superconducting liquid hydrogen energy pipeline terminal station;
electrolyzing, by a water electrolysis device at the superconducting liquid hydrogen energy pipeline starting station, clean water to generate oxygen and hydrogen, liquifying, by a hydrogen liquefier, the hydrogen to generate liquid hydrogen and delivering the liquid hydrogen generated to a first liquid hydrogen storage container for cooling the superconducting cable pipeline;
connecting the first AC power source to a first electrical power input rectifying station to rectify AC power from the first AC power source to generate the first DC power, and delivering the first DC power to a superconducting cable group of a superconducting cable pipe of the superconducting cable pipeline through a normal temperature cable group, a low temperature cable group, and a power adapter of the superconducting liquid hydrogen energy pipeline starting station;
transmitting, the first DC power through the superconducting cable group of the superconducting cable pipe of the superconducting cable pipeline, to the superconducting cable group of the superconducting cable pipe of the superconducting cable pipeline of the superconducting liquid hydrogen energy pipeline terminal station through a power adapter of the superconducting liquid hydrogen energy pipeline terminal station, a low temperature cable group, and a normal temperature cable group; and
inverting, by an output power inverter station of the superconducting liquid hydrogen energy pipeline terminal station, the DC power received to AC power, and delivering the AC power to an output to power grid.

19. The method according to claim 18, wherein the superconducting cable pipeline is formed by connecting a plurality of superconducting cable pipes in sequence, and each of the plurality of superconducting cable pipes comprises:
a superconducting cable group, wherein superconducting cable group is used to transmit the DC power;
a liquid hydrogen pipeline, wherein the superconducting cable group is positioned in a center of the liquid hydrogen pipeline and immersed in liquid hydrogen inside the liquid hydrogen pipeline;
a plurality of cable supporting members, wherein the plurality of cable supporting members is positioned around the superconducting cable group to support the superconducting cable group inside of the liquid hydrogen pipeline;
an internal insulation layer, wherein the internal insulation layer is positioned around an outside surface of the liquid hydrogen pipeline;
a liquid nitrogen cold shield, wherein the liquid nitrogen cold shield is positioned around an outside surface of the internal insulation layer; and
an external cold insulation layer, wherein external cold insulation layer is positioned around the liquid nitrogen cold shield.

20. The method according to claim 18, comprising:
installing one or more superconducting liquid hydrogen energy pipeline intermediate stations, between the superconducting liquid hydrogen energy pipeline starting station and superconducting liquid hydrogen energy pipeline terminal station to extend transmission distance of the superconducting liquid hydrogen energy pipeline system.
